(19) United States
(12) Patent Application Publication
(10) Pub. No.: US 2026/0266989 A1
(43) Pub. Date: Sep. 10, 2026

(54) METHOD OF MEASURING UNDERWATER DEPTH

(71) Applicant: Wavefront Systems Limited, Somerset (GB)

(72) Inventors: Robert CROOK, Somerset (GB); David WROBEL, Wiltshire (GB)

(73) Assignee: Wavefront Systems Limited, Somerset (GB)

(21) Appl. No.: 18/875,508

(22) PCT Filed: Jun. 6, 2023
(86) PCT No.: PCT/EP2023/065157

§ 371 Date: Dec. 16, 2024

(30) Foreign Application Priority Data
Jun. 17, 2022 (GB) 2208952.8

(51) Int. Cl. G01S 15/08; G01S 15/89

(52) U.S. Cl. CPC G01S 15/08; G01S 15/89

(57) ABSTRACT

A method of measuring underwater depth comprising: an active sonar translating (420) in a predetermined direction of travel through a water column, the active sonar having an acoustic transducer. A region of the water column is ensonified (402) as the active sonar travels over a plurality of time frames. A plurality of reflections is received (404) in respect of each of the plurality of time frames and each of a plurality of selected locations to be measured within a field of view of the transducer. A plurality of slant ranges and corresponding slant angles to the selected locations for each of the plurality of time frames is calculated. The slant ranges and slant angles and an estimate of a degree of refraction in the water column are used to calculate (416) a plurality of normalised depth estimates. A global relationship between the plurality of normalised depth estimates and squares of the plurality of slant ranges is modelled (584), and the relationship is used to update (588) the degree of refraction in respect of the plurality of selected locations.

The present invention relates to a method of measuring underwater depth, the method being of the type that, for example, actively ensonifies a water column. The present invention also relates to an underwater depth measurement apparatus of the type that, for example, actively ensonifies a water column.

Every year, a sizeable number of marine incidents occur, including vessel collisions and groundings. Causes of such incidents vary. They are dominated by human error, poor or non-existent marine charts or striking of hidden objects, for example ice or partially submerged containers. The financial cost associated with such incidents is considerable, but unfortunately there is also a cost in terms of loss of life: not only human life, but marine life that can be involved in collisions too.

It is therefore known to employ so-called Forward-Looking Sonar (FLS) systems to detect possible causes of incidents before they are reached by a vessel equipped with the forward-looking sonar system. Forward-looking sonar systems employ an active sonar detection technique, whereby a region of a water column is ensonified by an acoustic transceiver and reflections from ensonified features in the marine environment are received and interpreted in order to generate an acoustic “picture” of the ensonified marine environment ahead of the vessel. In this regard, by using very precise timing of the delay between transmission and reception, sonar processing can infer the range of any so-called “contacts”, namely objects in the ensonified marine environment that reflect acoustic signals transmitted by the acoustic transceiver. Additionally, using so-called “beamforming” acoustic processing techniques, the direction from which an acoustic reflection originates can also be determined.

However, typical forward-looking sonar systems only determine the two dimensions of range and bearing to a reflecting contact, making them inherently two-dimensional sensors. It is also desirable to be able to measure depth of a contact far ahead of the vessel equipped with the forward-looking sonar system, but measuring depth is challenging owing to refraction of acoustic signals in water. An emitted acoustic signal is deflected from a straight-line path that would otherwise be taken owing to changes in the refractive index of the medium, for example seawater, through which the acoustic signal is propagating. In the case of sea water, the refractive index of the water changes where material properties of the sea water change gradually, for example with depth. In this regard, temperature, salinity and/or pressure are examples of properties of seawater known to change with depth. For a given temperature gradient of the seawater with depth, the relative change in refractive index of sea water can be thousands of times greater as compared with air. As such, even a modest temperature gradient in sea water can cause significant refraction of underwater sound waves.

Little or no significant refraction may be experienced by acoustic signals in some regions in which a vessel is sailing, but it is still commonplace for regions to exist where changes in temperature and salinity with depth near a forward-looking sonar system can create considerable refraction, an effect known as “ray-bending” in sonar, where the term “ray” is used to define the direction in which the underwater sound is travelling.

As temperature and salinity profiles in seawater tend to be predominantly dependent upon depth, the effect of ray-bending is more pronounced for sound rays propagating horizontally than for sound waves propagating downwards. As such, acoustic energy transmitted horizontally can bend downwards to such a degree that the sound ray arrives at the seabed, for example, within a few hundred meters ahead of a vessel and a volume of seawater above the transmitted sound ray remains un-ensonified, meaning that objects in this region above refracted acoustic energy will not be detected by the forward-looking sonar system until they come within the ensonified region, which could be quite close to the vessel for objects high in the water column.

Consequently, existing forward-looking sonar systems attempting to place a contact additionally in depth lack a degree of coverage ahead of a vessel. In this regard, such systems are unaware that refraction is taking place and so will misplace, in depth, objects that are detected. Consequently, a sonar ray of a forward-looking sonar system transmitted horizontally, but intercepting a seabed owing to refraction, may be reported as an object at a range of, for example, 300 m, at the surface of the water, because the forward-looking sonar system assumes that the sonar ray is moving horizontally since this was the elevation direction of the ray at transmit time (transmit elevation beamforming) or receive time (receive elevation beamforming).

GB-A-1 330 472 relates to a forward-looking sonar system that enables depth to be determined provided a calibration process is performed so that target plan ranges can be assessed with respect to expected ranges assuming no refraction. However, such an approach introduces an undesirable calibration step and furthermore does not account for the travel of the vessel equipped with the forward-looking sonar system, the vessel necessarily entering new waters with different sound velocity profiles associated therewith and so rendering the calibration performed out of date. It is also undesirable for such a technique to depend upon the existence of selectable targets on the sea floor: many seabed regions will be bland homogenous scatterers without such distinct calibration targets.

According to a first aspect of the present invention, there is provided a method of a method of measuring underwater depth, the method comprising: an active sonar translating in a predetermined direction of travel through a water column, the active sonar having an acoustic transducer of a predetermined field of view; ensonifying a region of the water column with acoustic signals as the active sonar travels over a plurality of time frames; receiving a plurality of reflections of the acoustic signal in respect of each of the plurality of time frames and in respect of each of a plurality of selected locations to be measured within the field of view of the acoustic transducer; calculating a plurality of slant ranges and corresponding slant angles to the plurality of selected locations in respect of the each of the plurality of time frames; using the plurality of slant ranges and corresponding slant angles each in respect of the plurality of time frames and an estimate of a degree of refraction in the water column to calculate a plurality of normalised depth estimates; modelling a global relationship between the plurality of normalised depth estimates and squares of the plurality of slant ranges, respectively; using the modelled relationship to update the degree of refraction in respect of the plurality of selected locations.

The method may further comprise: re-calculating the plurality of compensated depths using the updated degree of refraction.

The method may further comprise: calculating a plurality of compensated depth estimates in respect of the plurality of time frames and the plurality of selected locations, respectively.

Calculation of the plurality of compensated depth estimates in respect of a time frame of the plurality of time frames and a location of the selected locations may comprises: using the estimate of the degree of refraction, a plurality of sampling slant ranges and corresponding sampling slant angles in respect of the time frame of the plurality of time frames and local to the location of the selected locations to calculate a plurality of peripheral compensated depth estimates in respect of the location of the selected locations; and calculating the compensated depth estimate by averaging the plurality of peripheral compensated depth estimates.

The location of the selected locations may comprise a region surrounding the location of the selected locations.

Calculation of the plurality of normalised depth estimates may comprise: calculating a plurality of uncompensated depth estimates and a corrected compensated depth estimate from the plurality of uncompensated depth estimates, the plurality of uncompensated depth estimates being in respect of a location of the plurality of selected locations and the each of the plurality of time frames; and calculating a plurality of deviations between the plurality of uncompensated depth estimates and the corrected compensated depth estimates.

The method may further comprise: calculating the plurality of uncompensated depths by estimating a depth refraction component in respect of the location of the plurality of sampling locations each of the plurality of time frames and removing the depth refraction component from the corresponding plurality of compensated depth estimates, respectively.

The method may further comprise: modelling a local relationship between the plurality of uncompensated depth estimates and a number of the squares of the plurality of slant ranges in respect of the location of the plurality of selected locations, respectively; calculating the corrected compensated depth estimate from the modelled local relationship.

The method may further comprise: modelling the local relationship between the plurality of uncompensated depths and the number of squares of the plurality of slant ranges using regression analysis.

Calculating the corrected compensated depth estimate may comprise: calculating an intercept with an uncompensated depth estimate axis in respect of the relationship between the plurality of uncompensated depths and the number of the squares of the plurality of slant ranges.

Calculation of the plurality of normalised depth estimates may comprises: calculating another plurality of uncompensated depth estimates and another corrected compensated depth estimate from the another plurality of uncompensated depth estimates, the another plurality of uncompensated depth estimates being in respect of another location of the plurality of selected locations and the each of the plurality of time frames; and calculating another plurality of deviations between the another plurality of uncompensated depth estimates and the another corrected compensated depth estimates.

Modelling the relationship between the plurality of normalised depth estimates and the squares of the plurality of slant ranges may further comprise: modelling the global relationship between the plurality of depth deviations and the another plurality of depth deviations and the squares of the plurality of slant ranges associated with the plurality of depth deviations and the another plurality of depth deviations using regression analysis in respect of the plurality of time frames and the location and the another location of the plurality of selected locations.

The method may further comprise: selecting a predetermined preliminary degree of refraction as the estimate of degree of refraction; and calculating the plurality of normalised depth estimates using the predetermined preliminary degree of refraction.

The modelling of the global relationship may be performed less frequently than the modelling of the local relationship.

According to a second aspect of the present invention, there is provided an underwater depth measurement apparatus comprising: an active sonar configured to translate, when in use, in a predetermined direction of travel through a water column, the active sonar having an acoustic transducer of a predetermined field of view; and a signal processing resource configured to support an uncompensated depth calculation module, a gradient calculation module and a data modelling module; wherein the active sonar is configured to ensonify a region of the water column with acoustic signals as the active sonar travels over a plurality of time frames; the active sonar is configured to receive a plurality of reflections of the acoustic signal in respect of each of the plurality of time frames and in respect of each of a plurality of selected underwater locations to be measured within the field of view of the acoustic transducer; the uncompensated depth calculation module is configured to calculate a plurality of slant ranges and corresponding slant angles to the plurality of selected underwater locations in respect of the each of the plurality of time frames; the uncompensated depth calculation module is configured to calculate a plurality of normalised depth estimates using the plurality of slant ranges and corresponding slant angles each in respect of the plurality of time frames and an estimate of a degree of refraction in the water column; the data modelling module is configured to model a global relationship between the plurality of normalised depth estimates and squares of the plurality of slant ranges, respectively; the gradient calculation module is configured to use the modelled relationship to update the degree of refraction in respect of the plurality of selected underwater locations.

It is thus possible to provide a method of measuring underwater depth that provides improved accuracy of depths measured. Advantageously, the method and apparatus does not require an initial calibration using identifiable seabed targets, and thus monitoring can commence without delay. Furthermore, in contrast with other known techniques, recalibration is not required when a vessel employing the apparatus and method enters a new underwater environment. Likewise, it is not necessary for the vessel to remain in the underwater environment in which calibration was initially performed. In any event, the properties of the underwater environment typically changes over time. It therefore follows that the cost to implement the method and apparatus is lower than calibration-based solutions, because a calibration environment does not have to be designed and provided and calibration does not need to be performed. Furthermore, even without knowledge of the properties of the underwater environment or changes thereto, a user of the method and apparatus is still able to obtain accurate depth information. In relation to the method and apparatus, no explicit action is expected by an end-user of the apparatus with respect to assisting in the performance of the method.

At least one embodiment of the invention will now be described, by way of example only, with reference to the accompanying drawings, in which:

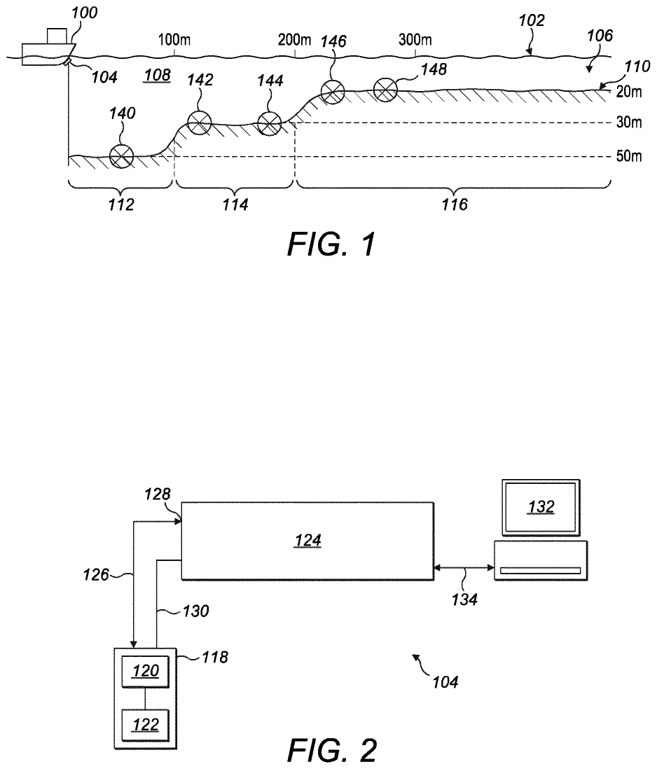

FIG. 1 is a schematic diagram of an underwater environment that is being monitored by a forward-looking sonar system constituting an embodiment of the invention;

FIG. 2 is a schematic diagram of the underwater sonar monitoring system of FIG. 1 in greater detail;

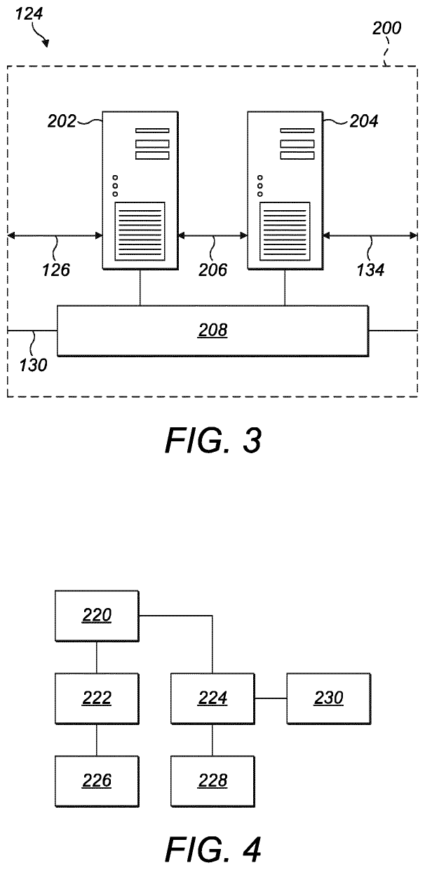

FIG. 3 is a schematic diagram of a processor platform of FIG. 2 in greater detail;

FIG. 4 is a high-level block diagram of functional elements supported by the forward-looking sonar system of FIGS. 1, 2 and 3;

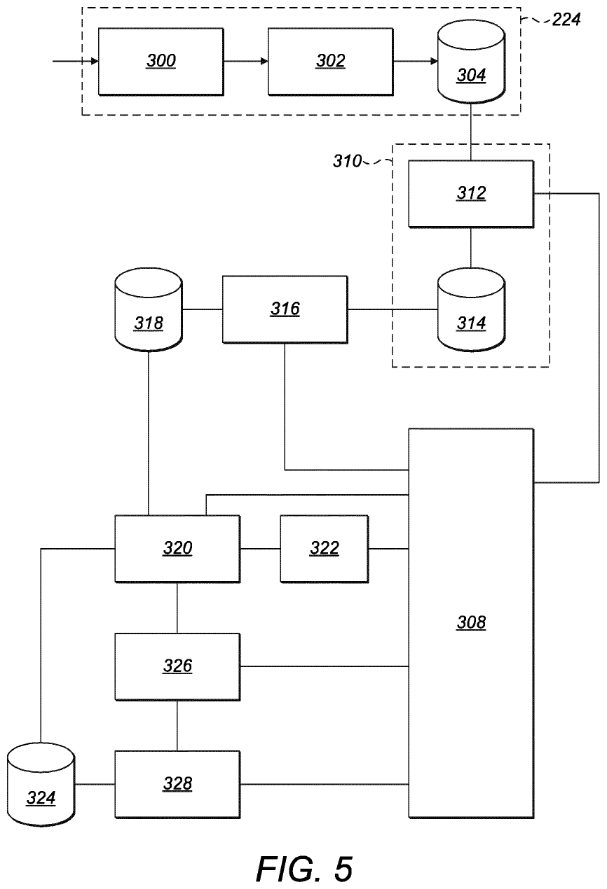

FIG. 5 is a block diagram of a processing chain supported by a receiver processing unit and a signal processing unit of FIG. 4;

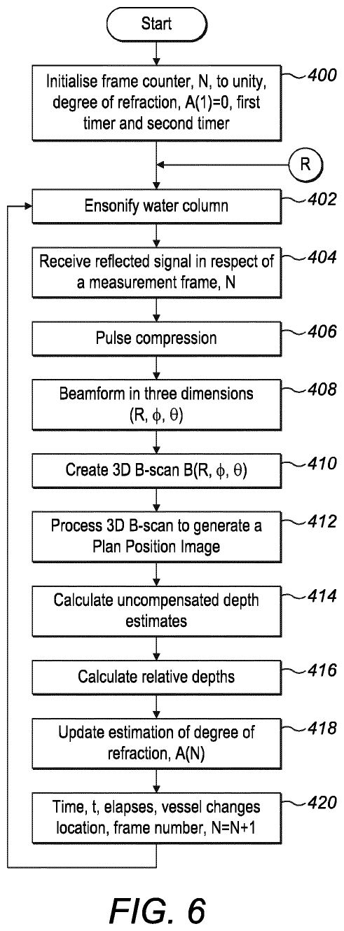

FIG. 6 is a flow diagram, in overview, of a method of measuring depth in an underwater environment and constituting another embodiment of the invention;

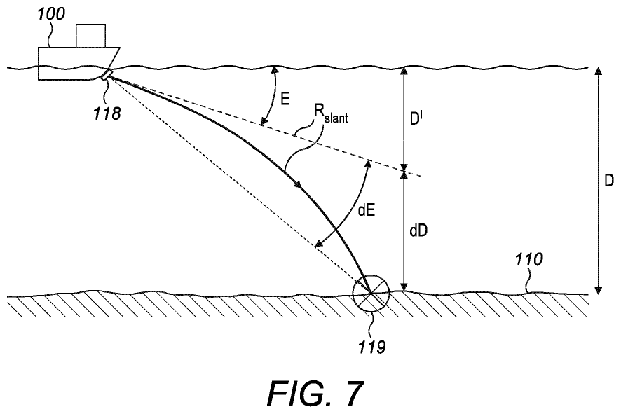

FIG. 7 is a schematic diagram illustrating the effect of an underwater sound velocity profile on emitted acoustic energy;

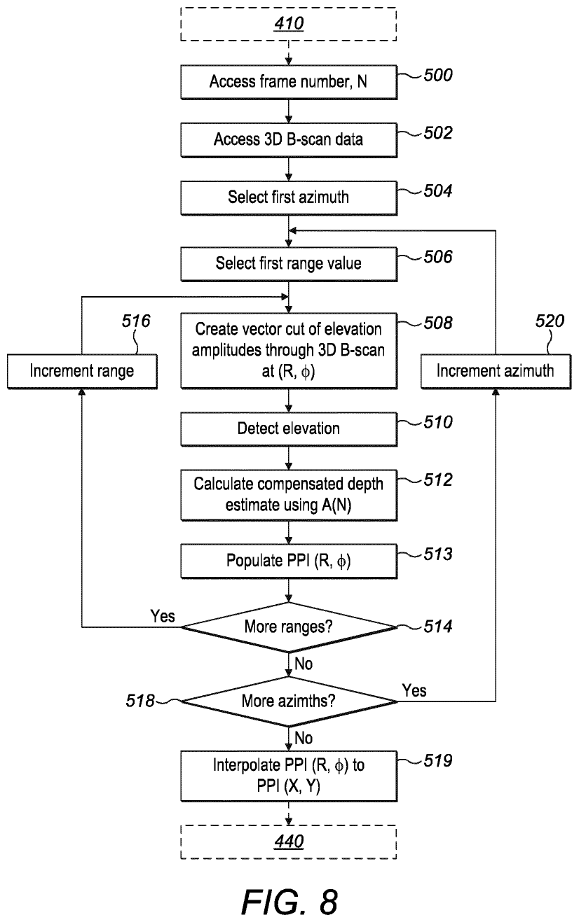

FIG. 8 is a flow diagram of method steps employed to generate a Plan Position Image in FIG. 6;

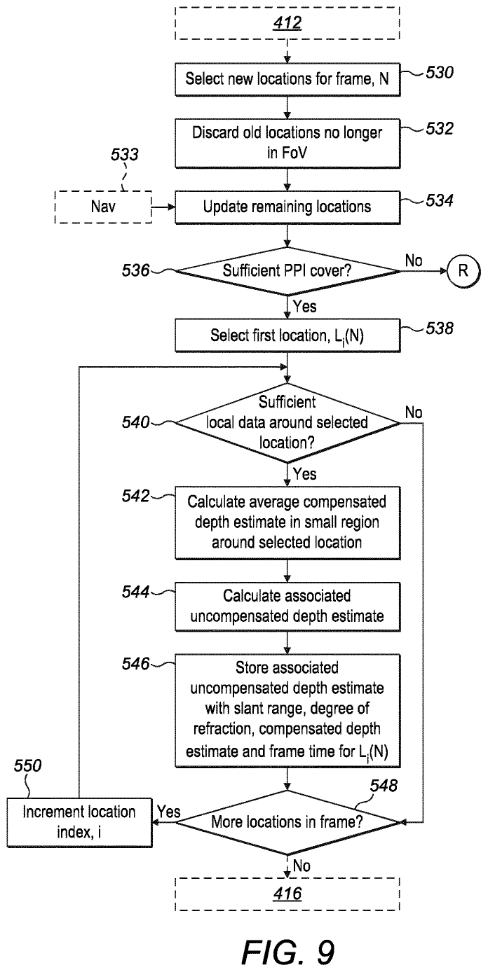

FIG. 9 is a flow diagram of method steps employed to calculate uncompensated depth estimates in FIG. 6;

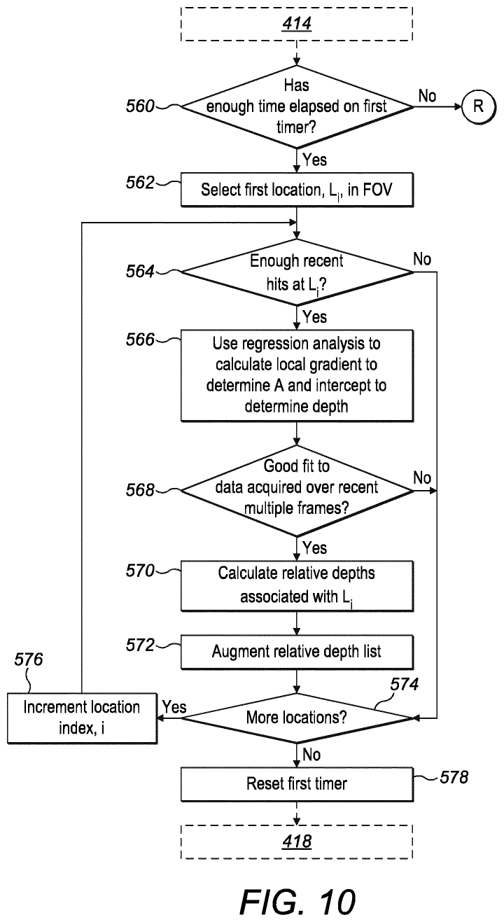

FIG. 10 is a flow diagram of method steps employed to calculate relative depths in FIG. 6;

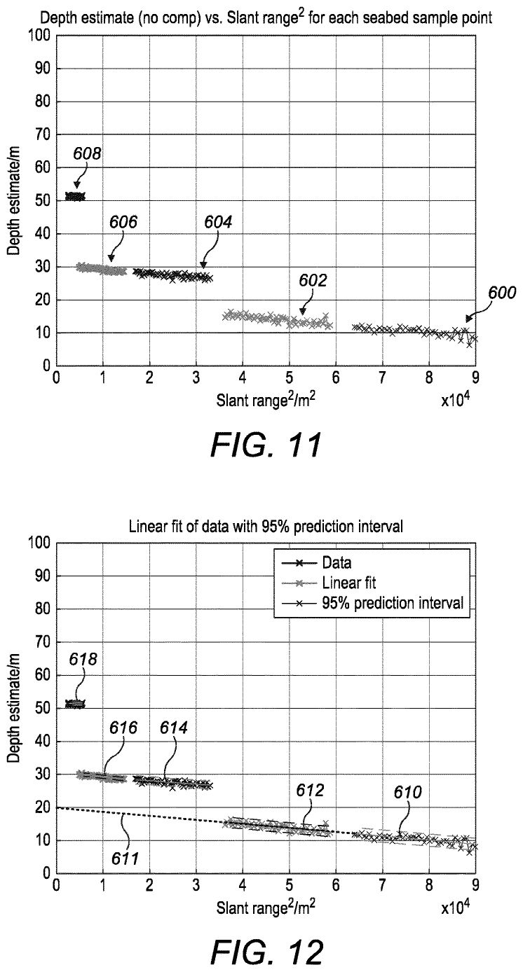

FIG. 11 is a graph of uncompensated depth estimates plotted against squares of slant ranges in respect of underwater locations;

FIG. 12 is the graph of FIG. 11 augmented by linear fit data;

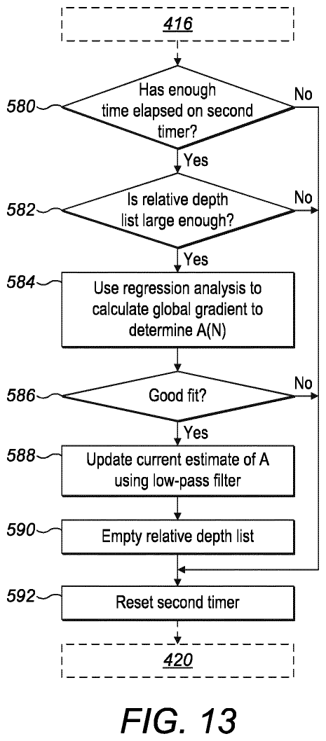

FIG. 13 is a flow diagram of method steps employed to update an estimate of a degree of refraction in FIG. 6;

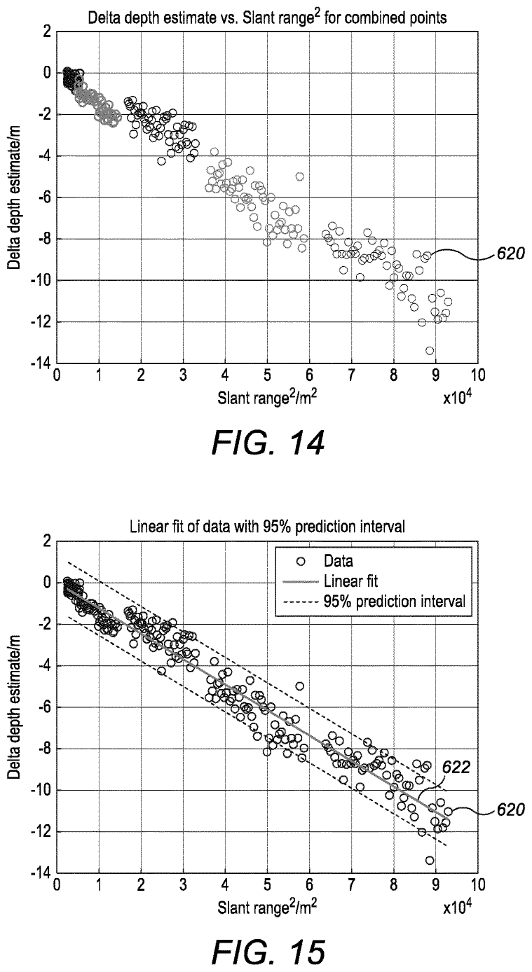

FIG. 14 is a graph of relative depths plotted against squares of slant ranges;

FIG. 15 is the graph of FIG. 14 augmented by linear fit data; and

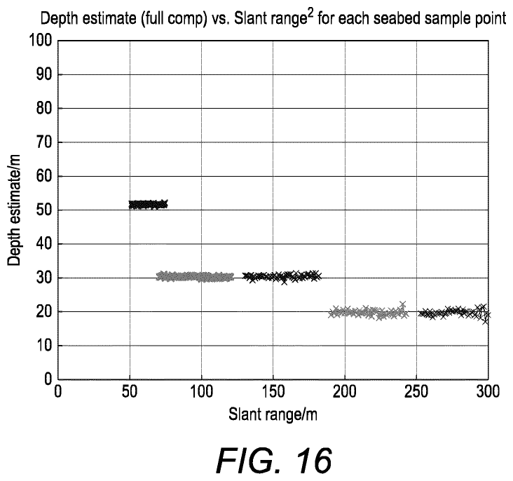

FIG. 16 is a graph of compensated depth plotted against slant range following recalculation using an updated degree of refraction value.

Throughout the following description identical reference numerals will be used to identify like parts.

Referring to FIG. 1, a vessel 100 travelling over a body of water 102, for example an ocean, carries an underwater forward-looking sonar system 104, for example an active sonar system, the forward-looking sonar system 104 being immersed in an underwater environment 106. In this example, purely to assist in the understanding of operation of the forward-looking sonar system 104, a region to be ensonified 108 of the underwater environment 106, constituting a water column, comprises a seabed 110 providing a terrain of varying depths. In this regard, the terrain comprises a first region 112 of a first depth, for example about 50 metres deep, a second region 114 adjacent the first region 112 of a second depth, for example about 30 metres deep, and a third region 116 adjacent the second region 114 of a third depth, for example about 20 metres deep. In this example, the first region 112 extends for about 100 metres in front of the vessel 100, the second regions 114 extends for about a further 100 metres after the first region 112, and the third region 116 extends for about several hundred metres after the second region 114.

Turning to FIG. 2, in this example, forward-looking sonar system 104 comprises a sonar head unit 118, for example a Vigilant™ sonar head, available from Wavefront Systems Limited, UK, the sonar head 118 comprising a projector transmit array and a receiver transducer array and associated signal processing circuitry. The projector of the sonar head 118 has a wide bandwidth transmission capability, having a central frequency of between about 70 KHz and 150 kHz and a bandwidth around 20 KHz or more. The projector of the sonar head 118 is programmable and supplied with a number of different selectable frequency modulated pulse shapes. The projector of the sonar head 118 typically has, in this example, an azimuth field of view of about 120° and an elevation field of view of about 40°.

In this example, the receiver transducer array of the sonar head 118 is a compact transducer array having between about 42 and 128 separately wired hydrophone channel elements, which can be used to form up to 256, equally spaced, receive beams, each with a 1.4° angular spacing over a 360° azimuth. In one example, 42 separately wired channel elements can be used to provide a 120° azimuth field of view.

As mentioned above, the sonar head 118 also comprises signal processing circuitry (not shown) to digitise, mix down to baseband, filter, multiplex and transfer the signals received by the receiver transducer array. The sonar head 118 also comprises attitude, heading reference and position sensors 120 to monitor orientation and position of the sonar head 118 and constitutes a source of orientation and position data in respect of receipt of sonar reflections. A data enrichment module 122 of the sonar head 110 is capable of enriching acoustic reflectivity data with attitude, heading and position information obtained from the attitude, heading reference and position sensors 120.

The sonar head 118 is operably coupled to a processor platform unit 124 via either a 75 m copper or 300 m or greater fibre-optic cable 126 coupled to an input/output port 128. A power supply cable 130 also couples the sonar head 118 to the processor platform unit 124. The processor platform unit 124 is, in this example, a Vigilant™ processor platform available from Wavefront Systems Limited, but adapted to operate in accordance with the method set forth herein. However, the skilled person will appreciate that other suitable computing platforms can be devised and provided.

The processor platform unit 124 is operably coupled to a workstation 132, for example a computing apparatus, such as a first Personal Computer (PC), via any suitable data communications link, for example an Ethernet link 134. The workstation 132 supports the execution of software, for example an operator console module, which provides a user-friendly display. In this example, the workstation 132 is a Vigilant™ command workstation, available from Wavefront Systems Limited.

Referring to FIG. 3, the processor platform unit 124 comprises a rugged housing, for example a case 200, comprising a processing resource, for example a computing apparatus, such as a second high-performance PC 202 operably coupled to a third high-performance PC 204 via, for example, a communications link, such as another Ethernet connection 206. In this example, the third PC 204 is operably coupled to the workstation 132 via the Ethernet link 134, and the second PC 202 is operably coupled to the sonar head 118 via the cable 126 and a suitable interface card (not shown), depending upon whether an electrical or optical connection is made to the sonar head 118.

Although, in this example, the first, second and third PCs 132, 202, 204 are connected using direct Ethernet connections, the skilled person will appreciate that a communications network, for example an Ethernet network, can be employed in order to interconnect the first, second and third PCs 132, 202, 204 as desired.

In order to power the forward-looking sonar system 104, at least in respect of the processor platform unit 124 and the sonar head 118, the processor platform unit 124 comprises a power distribution unit 208. The power distribution unit 208 comprises, for example, batteries in order to power the second PC 202, the third PC 204 and the sonar head 118. Of course, if a vessel-based power supply is available, the power distribution unit 208 is capable of deriving and delivering electrical power from this source. In this example, the power distribution unit 208 is operably coupled to the sonar head 118 via the power supply cable 130. However, the skilled person will appreciate that the power distribution unit 208 can be used also to power the workstation 132 or simply to power the second and third PCs 202, 204. In the event that the power distribution unit 208 is not used to power the sonar head 118, the sonar head 118 can be provided with its own power supply.

Turning to FIG. 4, in order to support the above-described high-level functionality, the second and third PCs 202, 204 cooperate to provide a control unit 220 operably coupled to a transmitter unit 222 and a receiver processing unit 224. The transmitter unit 222 is operably coupled to a logical projector array 226 of the transducer array of the sonar head 118 mentioned above. Similarly, the receiver processing unit 224 is operably coupled to a logical receive array 228 of the transducer array of the sonar head 118. The receiver processing unit 224 is also operably coupled to a signal processing resource 230. The signal processing resource 230 supports a number of computational functions that are performed in the course of executing the method described herein.

Referring to FIG. 5, the receiver processing unit 224 supports a pulse compression module 300 operably coupled to a beamforming module 302, the beamforming unit 302 being operably coupled to a B-scan store 304. The signal processing resource 230 supports calculation of estimates of a degree of refraction and comprises a local control module 308 operably coupled to a Plan Position Image module 310 that comprises a compensated depth calculator module 312 operably coupled to a compensated depth list store 314. An uncompensated depth calculator module 316 is operably coupled to the compensated depth list store 314, the local control module 308 and an uncompensated depth list store 318.

The uncompensated depth list store 318 is also operably coupled to a linear regression engine module 320, the linear regression engine module 320 being operably coupled to the local control module 308, a gradient calculation module 322, a relative depth list store 324 and an intercept calculation module 326. The gradient calculation module 322 and the intercept calculation module 326 are respectively operably couple to the local control module 308. The relative depth list store 324 is operably coupled to a relative depth calculation module 328, which is also operably coupled to the local control module 308 as well as the intercept calculation module 326.

In operation (FIG. 6), the sonar head 118 is, by virtue of installation on the underside of the vessel 100, immersed in the underwater environment 108 so as to submerge the sonar head 118 in the water in order to monitor the underwater environment 108. When monitoring of the underwater environment is to commence, the processor platform unit 124 and the workstation 132 are powered up. The workstation 132 loads and executes software to provide an operator of the system with graphical data and other information in accordance with the software provided by Wavefront Systems Limited. Likewise, the processor platform unit 124 executes software in order to process acoustic reflectivity images in the manner described herein. The processor platform unit 124, the workstation 132 and the sonar head 118 of the underwater forward-looking sonar system 104 therefore cooperate to support monitoring of the underwater environment 102 as follows.

During an initialisation stage (Step 400) a frame number variable, N, is initialised to unity and an initial degree of refraction variable, A(1), in respect of the first time frame, N, is set to zero. A first timer and a second timer are also initialised before the sonar head 118 ensonifies (Step 402) a region of the underwater environment 108 and receives acoustic reflections, constituting reverberant energy as a result of the ensonification, analogue data pertaining to the received acoustic reflections being provided by the logical receive array 228 to the receiver processing unit 224. In response to the received acoustic reflections arising from ensonification of the region of the underwater environment 108, the receiver processing unit 224 generates 3D beamformed amplitude data known as 3D B-scan data with dimensions of range (R), azimuth (φ) and elevation (θ).

In this regard, the receiver processing unit 224 receives (Step 404) the analogue acoustic signals obtained via the logical receive array 228 corresponding to C hydrophone elements of the receiver transducer array of the sonar head 118. The analogue acoustic signals comprise reverberant energy, which is digitally sampled by the receiver processing unit 224 at a rate F samples per second where F is a sampling rate satisfying Nyquist's theory. In some embodiments, the digitisation process can include further signal conditioning steps, for example complex heterodyning, digital filtering and decimation to provide a signal output digitised at a reduced complex sample rate F₀ that is less than the Nyquist sampling rate but greater than the system bandwidth. In any event, the C channels of hydrophone element data are digitally sampled at a sampling rate over a period of time constituting the time frame, N. The time frame, N, corresponds to a predetermined reporting range of receiver processing unit 224. The sampling process yields a package of data corresponding to C channels of C_{N} samples constituting a data frame. This process is repeated each time the sonar head 118 ensonifies the region of the underwater environment 108, and each frame of data generated is provided to the signal processing resource 230.

Referring to FIG. 7, when the sonar head 118 ensonifies the underwater environment 108, the acoustic energy emitted experiences a degree of “bending” or refraction, meaning that a crude assumption that the acoustic energy emitted travels in a straight line does not hold true. Based upon this assumption, a parameter of the seabed 110, for example depth can be reported incorrectly. As such, it should be appreciated that acoustic energy emitted by the sonar head 118 can be backscattered by the seabed 110 closer than the expected position of the location where backscattering is assumed to have taken place. In this regard, without the application of refraction compensation, an acoustic ray with an angle of elevation E degrees at the sonar head 118, which is associated with a straight line of travel of the acoustic energy, results in an uncompensated depth estimate, D′, of a point of backscattering 119 on the seabed, determined by the following trigonometric expression:

$${D}^{′} \approx {R}_{slant} \cdot sin ( \frac{E π}{180} ) \qquad ( 1 )$$

where Rₛₗₐₙₜ is slant range in metres from the acoustic head 118 to a point of backscattering on the seabed 119, assuming a straight line of travel of the acoustic energy and π/180 represents a conversion between degrees and radians. However, as a result of the refraction caused by the properties of the underwater environment 108, the actual acoustic ray follows a curved path from the sonar head 118 to the backscattering point 119 on the seabed 110. The angle of elevation associated with the straight line chord drawn between the sonar head 118 and the point of backscattering on the seabed 119, is greater than the angle of elevation E by an amount that can be considered an elevation error, dE, in degrees. Such an error leads to an error in estimated depth, D′. Consequently, a depth error, dD can be approximate as:

$$dD \approx {R}_{slant} \cdot dE \cdot \frac{π}{180} \qquad ( 2 )$$

$$\text{where:}$$

$$dE = \frac{{AR}_{slant}}{1000} \qquad ( 3 )$$

and where A is the degree of refraction in units of degrees/kilometre and dE is expressed in units of degrees.

A compensated depth estimate for the seabed backscatter point 119 on the seabed 110 is therefore given as:

$$D = ( {D}^{′} + dD ) \qquad ( 4 )$$

Referring back to FIG. 6 and the frame of data generated, which will be used to calculate an uncompensated depth estimate, the data frame generated is received by the pulse compression module 300 and each channel of the C channels of the data frame is correlated with a digitised replica of a transmitted pulse used to ensonify the region of the underwater environment 108, the digitised replica being the result of sampling the replica at the sampling frequency. The result of the correlation is the pulse compression (Step 406) of the C channels of the data frame, the pulse compressed data frame being passed to the beamforming module 302, which applies (Step 408) a spatial filtering operation to the data so as to form C_{B} focussed beams in predetermined directions. In this example, the beams are uniformly spaced in angular direction around a 120° azimuth field of view and uniformly spaced in angular direction in elevation (vertical plane) for each azimuth beam direction over this azimuth field of view. The number of temporal samples corresponding to each of the C_{B} beams following processing by the beamforming module 302 is C_{S}, which is about the same number of temporal samples contained in the data frame in respect of each of the C channels. The beamformed data set will be referred to hereafter as a 3D B-scan frame (Step 410) and are stored by the beamforming module in the 3D B-scan store 304. The 3D B-scan comprises a plurality of sets of samples respectively corresponding to a plurality of acoustic receiver beams. The nominal range scale associated with the 3D B-scan frame is R_{S}, where in this example R_{S}=c/2×C_{S}/F₀ where c is the prevailing average speed of sound in the ensonified region of the underwater environment.

The 3D B-scan frames generated are processed (Step 412) by the PPI module 310 in order to generate a Plan Position Image of the ensonified region of the underwater environment 108.

Turning to FIG. 8, the signal processing resource 230 accesses (Step 500) the frame number, N, variable. Thereafter, the 3D B-scan data stored in the B-scan store 304 above is accessed (Step 502). For a given azimuth and slant range, 3D B-scan amplitude data is available for each elevation beam direction. The compensated depth calculation module 312 selects a first azimuth (Step 504) and a first slant range, Rₛₗₐₙₜ, (Step 506) in respect of the stored 3D B-scan data. The azimuth (φ) and slant range values selected (Steps 504, 506) are used to create (Step 508) a vector of amplitudes from the stored 3D B-scan data in respect of the selected azimuth and slant range values. The vector created is a vector of amplitudes of elevation beams at the selected azimuth and slant range. In this example, the elevation, E, (Step 510) associated with the highest amplitude in the vector is selected and the slant range associated with the selected elevation is selected, and both are then used to calculate (Step 512) for this sonar relative to a location, L, defined by slant range R_{L}(N) and azimuth φ_{L}(N), a compensated depth estimate D_{L}(N) for frame N using the uncompensated depth estimate D_{L}′ (N) for frame N and a current estimate for the degree of refraction A(N) using the following equation derived from the equations above:

$${D}_{L} ( N ) = {D}_{L}^{′} ( N ) + \frac{A ( N ) \cdot {{R}_{L} ( N )}^{2} \cdot π}{1000 \cdot 180} \qquad ( 5 )$$

The compensated depth calculation module 312 then populates (Step 513) a PPI with the calculated compensated depth estimate in respect of this location L in respect of the associated slant range, R_{L}, and azimuth, φ_{L}. Thereafter, the compensated depth calculation module 312 determines (Step 514) whether the B-scan data in respect of the currently selected azimuth contains more slant range data. In the event that further slant range data remains to be processed, the compensated depth calculation module 312 increments (Step 516) within the B-scan data to a subsequent slant range and the above steps (Steps 508 to 514) are repeated. Once no further slant ranges in respect of the selected azimuth remain, the compensated depth calculation module 312 determines (Step 518) whether further data in respect of other azimuths within the B-scan data remain to be processed. In the event that further azimuth-related data remains to be processed, the compensated depth calculation module 312 continues stepping through the remaining azimuths (Step 520) and the above-described processing steps are repeated (Steps 508 to 518) until all of the B-scan data has been processed in respect of all azimuths available. The resulting data set is a PPI expressed in by reference to slant range and azimuth. To facilitate subsequent processing of the PPI, in this example, the compensated depth module 312 interpolates (Step 519) the PPI in the frame of reference of slant range and azimuth to a cartesian coordinate system and stores the interpolated PPI in the compensated depth list store 314.

The PPI is then processed further in order to calculate (Step 414; FIG. 6) uncompensated depth estimates. Turning to FIG. 9, an Earth-centred fixed reference frame is employed to specify locations and, as such, as the vessel advances positionally, some locations in the Earth-centred reference frame enter into the field of view of the sonar head 118 and some leave the field of view of the sonar head 118. In this regard, knowing the field of view of the sonar head 118 and having access to navigation data, the uncompensated depth calculator module 316 determines and selects (Step 530) new locations of the Earth-centred reference frame that have entered the field of view of the sonar head 118 in respect of the current frame, N. The uncompensated depth calculator module 316 also determines and discards/deselects (Step 532) existing locations of the Earth-centred reference frame that have exited from the field of view of the sonar head 118 in respect of the current frame, N. Additionally, using the navigation data 533 available, the uncompensated depth calculator module 316 updates (Step 534) a mapping of the correspondence of the field of view of the sonar head 118 to the Earth-centred reference frame.

The uncompensated depth calculator module 316 then analyses the cartesian PPI generated with respect to the field of view of the sonar head 118 and determines (Step 536) whether the PPI contains a sufficient number of compensated depth estimates for the current frame, N, to enable estimation of the refraction factor, A, sufficiently accurately. In the event that the number of depth estimates is insufficient, the uncompensated depth calculator module 316 terminates the processing of the PPI and the uncompensated depth calculator module 316 awaits the generation of a subsequent PPI in a subsequent frame, N. In this regard, the above-described steps (Steps 402 to 414) are repeated until sufficient PPI coverage exists.

If sufficient PPI coverage exists, the uncompensated depth calculator module 316 then selects (Step 538) a first location, Lᵢ, from the locations within the field of view of the sonar head 118 in respect of the current frame, N. As part of the processing of the PPI, it is necessary to average compensated depth estimates about a predetermined area, for example a 10 m×10 m area centred on the selected location, Lᵢ. For the predetermined area, the uncompensated depth calculator module 316 determines (Step 540), for the sake of integrity of processing, whether within the predetermined area centred on the selected location, Lᵢ, sufficient data points exist. In the event that insufficient data exists in the PPI within the predetermined area centred on the selected location, Lᵢ, the uncompensated depth calculator module 316 disregards the currently selected location, Lᵢ, and determines (Step 548) whether further locations within the PPI remain to be selected and processed. Otherwise, the uncompensated depth calculator module 316 uses the compensated depth estimates within the predetermined area centred on the selected location, Lᵢ, to calculate (Step 542) an average compensated depth estimate using the compensated depth estimates available within the predetermined area centred on the selected location, Lᵢ.

Following calculation of the average compensated depth estimate (Step 542), the uncompensated depth calculator module 316 calculates (Step 544) an uncompensated depth estimate associated with the average compensated depth estimate calculated, using the following equation:

$${D}_{Li}^{′} ( N ) = {D}_{Li} ( N ) - A ( N ) * {{R}_{Li} ( N )}^{2} * ( π / 180 ) / 1000 \qquad ( 6 )$$

Where D′_{Li}(N) is the uncompensated depth estimate for the selected location, Lᵢ, in respect of the frame, N, and D_{Li}(N) is the corresponding average compensated depth estimate in respect of the current frame, N, A(N) is the degree of refraction previously calculated for use in respect of the frame, N and R_{Li}(N) is the slant range associated with the selected location, Lᵢ in respect of frame, N. This equation is derived from the equations set forth above in respect of the estimated depth and the depth error (equations (2), (3) and (4)).

Once the uncompensated depth estimate has been calculated (Step 544), the uncompensated depth estimate is stored (Step 546) in the uncompensated depth list store 318 in respect of the current location, Lᵢ, by the uncompensated depth calculator module 316 along with the associated average compensated depth estimate, D_{Li}(N), the associated slant range, Rui, the degree of refraction A(N), and the time frame, N. In this regard, it should be appreciated that the uncompensated depth list store 318 accumulates these values over multiple frames throughout the duration of operation of the underwater forward-looking sonar system 104.

Thereafter, the uncompensated depth calculator module 316 determines (Step 548) whether further locations within the PPI remain to be selected and processed. In the event that further locations need to be processed, a record of the location, Lᵢ, for example variable i, is incremented (Step 550) and the above processing steps (Steps 540 to 548) are repeated in respect of the next selected location, Lᵢ. Otherwise, the uncompensated depth calculator module 316 proceeds to subsequent processing steps for calculating relative depths (Step 416).

Turning to FIG. 10, the linear regression engine 320, with reference to the first timer, determines (Step 560) whether a sufficient amount of time has elapsed, implying a sufficient quantity of new data has been generated from ensonifying the region of the underwater environment 108 to generate further relative depths. If insufficient time has elapsed, the linear regression engine 320 terminates the processing of the uncompensated depth estimates and the linear regression engine 320 awaits the generation of a subsequent PPI in a subsequent frame, N. In this regard, the above-described steps (Steps 402 to 414) are repeated until sufficient time has elapsed.

If sufficient time has elapsed, the linear regression engine 320 selects (Step 562) a first location, Lᵢ, within the field of view of the sonar head 118. The linear regression engine 320 then determines (Step 564) whether the uncompensated depth estimates calculated are sufficiently recent, because refraction conditions can change over time and thus the uncompensated depth estimates may not correspond to current refraction conditions, for example if the uncompensated depth estimates are in respect of a historical period of time where the vessel 100 was anchored in a harbour.

If insufficiently recent data points are available in respect of the currently selected location, Lᵢ, the linear regression engine 320 determines (Step 574) whether uncompensated depth estimates in respect of further locations remain to be selected and processed. Otherwise, the signal processing resource 230 proceeds to calculate a local gradient to determine a local degree of refraction value in respect of the current location, Lᵢ, and an associated depth intercept on the depth estimate axis. In this regard, to assist comprehension of this method, the uncompensated depth estimates and the square of the respective slant ranges, R_{L}, can be represented visually as a plot of the uncompensated depth estimates and the squares of the slant ranges (FIG. 11). The plot is in respect of multiple frames over the duration of operation of the underwater forward-looking sonar system 104. Using linear regression to model locally, a gradient of the uncompensated depth estimates vs the squares of the respective slant ranges is calculated (Step 566) by the linear regression engine 320, which can be seen visually in FIG. 12 for ease of understanding. In this regard, it should be appreciated that the slant ranges to the current location, Lᵢ, in respect of each time frame is employed as the respective slant ranges mentioned above. Referring back to FIG. 1, the PPI comprises data associated with a first location 140, a second location 142, a third location 144, a fourth location 146 and a fifth location 148 on the seabed 110. Of course, the PPI typically comprises data in respect of other locations, but for the sake of clarity and conciseness of description, only the first, second, third, fourth and fifth locations 140, 142, 144, 146, 148 will be considered herein.

In FIG. 11, a first set of data points 600 correspond to uncompensated depth estimates in respect of the fifth location 148. A second set of data points 602 correspond to uncompensated depth estimates in respect of the fourth location 146. A third set of data points 604 correspond to uncompensated depth estimates in respect of the third location 144. A fourth set of data points 606 correspond to uncompensated depth estimates in respect of the second location 142, and a fifth set of data points 608 correspond to uncompensated depth estimates in respect of the first location 140. Therefore, referring to FIG. 12, the linear regression engine 320 implements (Step 566) a regression analysis algorithm to fit a first line 610 to the first set of data points 600 and from the fitted line, the gradient calculation module 322 calculates a first gradient and the intercept calculation unit 326 calculates a first depth intercept 611 on the depth estimate axis in respect of the first line 610. Once the first line 610 has been fitted to the first set of data points 600, the linear regression engine 320 checks (Step 568) the goodness of fit of the first line 610. If the fit is poor as measured against one or more predetermined criteria, the linear regression engine 320 determines (Step 574) whether uncompensated depth estimates in respect of further locations remain to be selected and processed. Otherwise, the relative depth calculation module 328 proceeds to normalise the variation of depth with the square of slant range by calculating (Step 570) a relative depth in respect of the currently selected location, Lᵢ, using the following equation:

$${D}_{LiR} ( N ) = {D}_{Li}^{′} ( N ) - {D}_{Li} \qquad ( 7 )$$

where D_{LiR}(N) is the relative depth for the location, Lᵢ, in respect of frame, N, and D′_{Li}(N) is the calculated uncompensated depth estimate for the location, Lᵢ, in respect of the frame, N, and D_{Li} is the intercept of the fitted line with the depth estimate axis, for example the first line 610 at the intercept 611. A relative depth list is maintained by relative depth calculation module 328 in the relative depth list store 324 associating the location, Lᵢ, the relative depth, D_{LiR}(N), and the associated slant range, Rui, in respect of the current frame, N. Once a first relative depth has been calculated in respect of the first set of data points 600, the relative depth list is augmented (Step 572) by the relative depth calculation module 328 with the first relative depth and associated slant range, location and frame. Thereafter, the linear regression engine 320 determines (Step 574) whether uncompensated depth estimates in respect of further locations remain to be selected and processed. In the event that uncompensated depth estimates in respect of further locations need to be processed, the variable tracking the processing of locations, for example i, is incremented (Step 576) and the above process is repeated (Steps 560 to 572) in respect of the remaining locations for which uncompensated depth estimates have not been processed, for example (FIG. 12) a second line 612 is fitted to the second set of data points 602 and an associated second gradient and a second intercept of the second line 612 are calculated. A second relative depth is then calculated in respect of the second set of data points 602 by the relative depth calculation module 328. Similarly, a third gradient, a third intercept and a third relative depth are calculated in respect of the third set of data points 604 by fitting a third line 614 to the third set of data points 604, a fourth gradient, a fourth intercept and a fourth relative depth are calculated in respect of the fourth set of data points 606 by fitting a fourth line 616 to the third set of data points 606, and a fifth gradient, a fifth intercept and a fifth relative depth are calculated for the fifth set of data points 608 by fitting a fifth line 618 to the fifth set of data points 608.

Once relative depths have been calculated in respect of all locations where the calculation of relative depths is possible, linear regression engine 320 resets (Step 578) the first timer and the signal processing resource 230 proceeds to calculate (Step 418), depending upon circumstances, an improved estimate of the degree of refraction, A. Referring to FIG. 13, the linear regression engine 320, with reference to the second timer, determines whether sufficient time has elapsed (Step 580) before which calculation of the degree of refraction, A, should take place. In this regard, a greater amount of time is, in this example, permitted to elapse as compared with the first timer, because the degree of refraction is calculated less often than the calculation of relative depths, because the degree of refraction in respect of the region of the underwater environment 108 changes slowly. However, in other examples, the degree of refraction can be calculated substantially at the same time as the relative depths, but at a cost of increased processing demand.

If insufficient time has elapsed, the linear regression engine 320 aborts processing of the relative depth list and the signal linear regression engine 320 awaits the generation of a subsequent PPI in a subsequent frame, N. In this regard, the above-described steps (Steps 402 to 416) are repeated until sufficient time has elapsed.

However, if sufficient time has elapsed, the linear regression engine 320 then determines (Step 582) whether the relative depth list is large enough to support the use of regression analysis on the data points contained in the relative depth list to model a global relationship between relative depth and squares of slant ranges. If the relative depth list contains insufficient data points, the linear regression engine 320 terminates the processing of the relative depth list and the linear regression engine 320 awaits the generation of a subsequent PPI in a subsequent frame, N. In this regard, the above-described steps (Steps 402 to 416) are repeated until sufficient data points are available.

If, however, the relative depth list is sufficiently large for regression analysis to be performed, the data points from the relative depth list vs the square of the slant range, a visualisation of which can be found in FIG. 14, are then processed by the linear regression engine 320 by applying (Step 584) a regression analysis algorithm to the relative depth vs the square of the slant range data 620 from the relative depth list in order to fit a degree of refraction line 622 (FIG. 15) to the data 620. In this regard, it should be appreciated that the slant ranges to the locations participating in the linear regression and in respect of each time frame are employed as the slant ranges mentioned above. Once the degree of refraction line 622 has been fitted, the gradient calculation module 322 calculates the gradient of the degree of refraction line 622 to obtain the degree of refraction, A, using the fact that the gradient is related to the degree of refraction by the factor of 180/π.

Once the degree of refraction 622 line has been fitted to the data 620, the linear regression engine 320 checks (Step 586) the goodness of fit of the degree of refraction line 622. If the fit is poor as measured against one or more predetermined criteria, the linear regression engine 320 terminates the processing of the relative depth list and the linear regression engine 320 awaits the generation of a subsequent PPI in a subsequent frame, N. In this regard, the above-described steps (Steps 402 to 416) are repeated until a line can be calculated that fits the data 620 sufficiently well.

However, if the fit is found to be good, then the gradient, which is related to the degree of refraction by a factor of 180/π, is used to update (Step 588) the value of the degree of refraction, A, using a low-pass filter in order to ensure variation of the estimate of the degree of refraction, A, is smooth. Thereafter, the relative depth list is emptied (Step 590) and thus readied for a subsequent iteration of the calculation of the degree of refraction, A. The second timer is also reset (Step 592).

Returning to FIG. 1, time elapses, the vessel 100 may advance towards a destination, and the frame number, N is incremented (Step 420) before the above-described steps (Steps 402 to 418) are repeated.

Referring to FIG. 16, following a number of iterations to recalculate the degree of refraction, A, it can be seen that the corrected depths are consistent for the respective depths encountered by the underwater forward-looking sonar system 104, demonstrating that the method described above performs well.

The skilled person should appreciate that the above-described implementations are merely examples of the various implementations that are conceivable within the scope of the appended claims. Indeed, it should be appreciated that although, in above examples, linear regression has been employed in order to fit a line to data, any other suitable and appropriate mathematical technique can be employed. Throughout the above description of the examples of the invention, a single global estimate of the degree of refraction, A, has been made using available depth estimate data across the entire sonar range swathe. However, such an approach assumes that the sound velocity profile for the water column is approximately linear with depth. However, where the sound velocity profile has a significantly nonlinear dependency on depth, it should be appreciated that a piecewise approach can be taken and the range scale of the sonar can be divided into slant-range interval segments and a respective value for the degree of refraction, A, can be calculated in respect of each segment using the processing technique described above. Thereafter, each value of the degree of refraction, A, in respect of each slant-range interval segment can be used to correct depths for locations which fall within the corresponding slant-range interval.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

What is claimed is:

1. A method of measuring underwater depth, the method comprising:
an active sonar translating in a predetermined direction of travel through a water column, the active sonar having an acoustic transducer of a predetermined field of view;
ensonifying a region of the water column with acoustic signals as the active sonar travels over a plurality of time frames;
receiving a plurality of reflections of the acoustic signal in respect of each of the plurality of time frames and in respect of each of a plurality of selected locations to be measured within the field of view of the acoustic transducer;
calculating a plurality of slant ranges and corresponding slant angles to the plurality of selected locations in respect of the each of the plurality of time frames;
using the plurality of slant ranges and corresponding slant angles each in respect of the plurality of time frames and an estimate of a degree of refraction in the water column to calculate a plurality of normalised depth estimates;
modelling a global relationship between the plurality of normalised depth estimates and squares of the plurality of slant ranges, respectively; and
using the modelled relationship to update the degree of refraction in respect of the plurality of selected locations.

2. The method according to claim 1, further comprising:
re-calculating the plurality of compensated depths using the updated degree of refraction.

3. The method according to claim 1, further comprising:
calculating a plurality of compensated depth estimates in respect of the plurality of time frames and the plurality of selected locations, respectively.

4. The method according to claim 3, wherein calculation of the plurality of compensated depth estimates in respect of a time frame of the plurality of time frames and a location of the selected locations comprises:
using the estimate of the degree of refraction, a plurality of sampling slant ranges and corresponding sampling slant angles in respect of the time frame of the plurality of time frames and local to the location of the selected locations to calculate a plurality of peripheral compensated depth estimates in respect of the location of the selected locations; and
calculating the compensated depth estimate by averaging the plurality of peripheral compensated depth estimates.

5. A The method according to claim 1, wherein the location of the selected locations comprises a region surrounding the location of the selected locations.

6. A The method according to claim 1, wherein calculation of the plurality of normalised depth estimates comprises:
calculating a plurality of uncompensated depth estimates and a corrected compensated depth estimate from the plurality of uncompensated depth estimates, the plurality of uncompensated depth estimates being in respect of a location of the plurality of selected locations and the each of the plurality of time frames; and
calculating a plurality of deviations between the plurality of uncompensated depth estimates and the corrected compensated depth estimates.

7. The method according to claim 6, further comprising:
calculating the plurality of uncompensated depths by estimating a depth refraction component in respect of the location of the plurality of sampling locations each of the plurality of time frames and removing the depth refraction component from the corresponding plurality of compensated depth estimates, respectively.

8. The method according to claim 6, further comprising:
modelling a local relationship between the plurality of uncompensated depth estimates and a number of the squares of the plurality of slant ranges in respect of the location of the plurality of selected locations, respectively;
calculating the corrected compensated depth estimate from the modelled local relationship.

9. The method according to claim 8, further comprising:
modelling the local relationship between the plurality of uncompensated depths and the number of squares of the plurality of slant ranges using regression analysis.

10. The method according to claim 6, wherein calculating the corrected compensated depth estimate comprises:
calculating an intercept with an uncompensated depth estimate axis in respect of the relationship between the plurality of uncompensated depths and the number of the squares of the plurality of slant ranges.

11. The method according to claim 6, wherein calculation of the plurality of normalised depth estimates comprises:
calculating another plurality of uncompensated depth estimates and another corrected compensated depth estimate from the another plurality of uncompensated depth estimates, the another plurality of uncompensated depth estimates being in respect of another location of the plurality of selected locations and the each of the plurality of time frames; and
calculating another plurality of deviations between the another plurality of uncompensated depth estimates and the another corrected compensated depth estimates.

12. The method according to claim 11, wherein modelling the relationship between the plurality of normalised depth estimates and the squares of the plurality of slant ranges further comprises:
modelling the global relationship between the plurality of depth deviations and the another plurality of depth deviations and the squares of the plurality of slant ranges associated with the plurality of depth deviations and the another plurality of depth deviations using regression analysis in respect of the plurality of time frames and the location and the another location of the plurality of selected locations.

13. The method according to claim 1, further comprising:
selecting a predetermined preliminary degree of refraction as the estimate of degree of refraction; and
calculating the plurality of normalised depth estimates using the predetermined preliminary degree of refraction.

14. The method according to claim 1, wherein the modelling of the global relationship is performed less frequently than the modelling of the local relationship.

15. An underwater depth measurement apparatus comprising:
an active sonar configured to translate, when in use, in a predetermined direction of travel through a water column, the active sonar having an acoustic transducer of a predetermined field of view; and
a signal processing resource configured to support an uncompensated depth calculation module, a gradient calculation module and a data modelling module;
wherein the active sonar is configured to ensonify a region of the water column with acoustic signals as the active sonar travels over a plurality of time frames;
the active sonar is configured to receive a plurality of reflections of the acoustic signal in respect of each of the plurality of time frames and in respect of each of a plurality of selected underwater locations to be measured within the field of view of the acoustic transducer;
the uncompensated depth calculation module is configured to calculate a plurality of slant ranges and corresponding slant angles to the plurality of selected underwater locations in respect of the each of the plurality of time frames;
the uncompensated depth calculation module is configured to calculate a plurality of normalised depth estimates using the plurality of slant ranges and corresponding slant angles each in respect of the plurality of time frames and an estimate of a degree of refraction in the water column;
the data modelling module is configured to model a global relationship between the plurality of normalised depth estimates and squares of the plurality of slant ranges, respectively;
the gradient calculation module is configured to use the modelled relationship to update the degree of refraction in respect of the plurality of selected underwater locations.
